(19) United States
(12) Patent Application Publication
(10) Pub. No.: US 2024/0010446 A1
(43) Pub. Date: Jan. 11, 2024

(54) INDIVIDUAL EGG TRANSPORT DEVICE, COMPLEMENTARY FILLING FACILITY AND ASSOCIATED METHOD

(71) Applicant: NECTRA, PLOUVORN (FR)

(72) Inventors: Ephrem ADJANOHOUN, PACE (FR); Jean-Claude YVIN, PLOUGOULM (FR); Alain NEGER, PLESTIN-LES-GREVES (FR)

(21) Appl. No.: 18/255,851

(22) PCT Filed: Nov. 24, 2021
(86) PCT No.: PCT/FR2021/052083

§ 371 Date: Jun. 2, 2023

(30) Foreign Application Priority Data
Dec. 3, 2020 (FR) FR2012652
Jan. 7, 2021 (FR) FR2100126

(51) Int. Cl. B65G 47/91; B65B 23/08

(52) U.S. Cl. CPC B65G 47/91; B65B 23/08; B65G 2201/0208; A01K 43/00

(57) ABSTRACT

The invention relates to an individual egg transport device, characterized in that it includes: —an upper cup provided to receive an egg, —a base provided to ensure a stable position of the egg when the individual device is placed on a conveyor belt, —a gripping element allowing a gripping member to grasp the individual device in order to transport it from a first location to a second location. The invention also proposes a gripping member, a filling facility and a filling method using the individual egg transport device.

### TECHNICAL FIELD OF THE INVENTION

The present invention relates to industrial facilities for poultry farming. The invention relates more particularly to industrial facilities in which eggs are transported on trays provided with appropriate housings, or cells. In particular, it involves fertilized eggs provided to be transported to incubators in order to allow chicks to hatch.

### TECHNICAL BACKGROUND

In industrial facilities for poultry farming, it is necessary to sort the breeding eggs into different categories, in particular as a function of their weight and in order to remove the eggs not fertilized or not incubated due, for example, to poor quality, a cracked or dirty shell, a double egg, etc. Generally, the eggs arrive on transport trays comprising a number N of housings. The eggs are then placed on a conveyor belt where they roll on to sorting stations. Following the sorting, the eggs of the same category are grouped, during a so-called stabilization step, to be placed subsequently on a transport tray.

While the eggs roll on the mat they strike one another, which may cause micro-breaks on the eggshells. Furthermore, by rolling the eggs, the risks of contamination are significantly increased.

### SUMMARY OF THE INVENTION

The invention proposes an individual egg transport device, characterized in that it includes:
an upper cup provided to receive an egg,
a base provided to ensure a stable position of the cup on a conveying element,
a gripping element allowing a gripping member to grasp the individual device in order to transport it from a first location to a second location.

According to other advantageous characteristics of the device:
the gripping element comprises a magnet, or a metal part, which is arranged under the upper cup to allow the gripping member to grasp the individual device by magnetic attraction;
the individual device includes a surface such as a bump capable of allowing the gripping of the individual device by a suction cup;
it includes a peripheral groove;
the base includes metal pellets distributed on the bottom of the base.

The invention also proposes a gripping member intended to grasp an individual egg transport device according to one of the preceding features, characterized in that it includes an arm provided with a gripping rod which is slidably mounted relative to the arm, in that the free end of the gripping rod includes a gripping tip capable of grasping the individual device by magnetic attraction, and in that the arm includes at its free end, on the side of the gripping tip, a suction cup coaxial with the gripping rod, able to grasp an egg by suction.

According to other advantageous features of the gripping member:
the gripping rod is mounted free to slide in the arm.

The invention also proposes an assembly for egg transport, characterized in that it includes a gripping member according to one of the preceding features and an individual device according to one of the preceding features.

The invention also proposes a movable gripping shuttle characterized in that it includes at least N gripping members according to the preceding feature, these N gripping members being able to grasp up to N eggs arranged either in N housings of an egg transport tray, or in N individual devices according to one of the preceding features.

The invention also proposes a facility for filling egg transport trays, characterized in that it includes:
a first conveyor line which is designed to supply the facility with transport trays of eggs comprising N housings each able to receive an egg in the vertical position,
a second conveyor line which is designed to convey individual devices according to one of the preceding features,
a third conveyor line which is designed to output egg transport trays comprising X housings each able to receive an egg in the vertical position,
at least one gripping shuttle, which is movable between the first conveyor line and the second conveyor line, so that it can:
   during a first step, grasp a first load of eggs on a first tray comprising a number of eggs M less than N, transport the first load of eggs to the second conveyor line, and deposit the first load of eggs into a first group of individual devices,
   during a second step, grasp a second load of eggs arranged in a second group of individual devices arranged on the second conveyor line, transport the second load of eggs to a third main conveyor line, and deposit the second load of eggs in the housings of a tray comprising X housings.

According to other features of the facility according to the invention:
the second conveyor line includes a first station upstream of the conveying flow where the individual devices are grouped to form the first group, and a second station downstream of the conveying flow where the individual devices are grouped to form the second group;
the facility includes a first gripping shuttle which transports the first load of eggs and a second gripping shuttle which is movable between the first station and a third station arranged upstream, relative to the first station, so as to be able to transport the empty individual devices of the first group from the first station to the third station;
the facility includes a third gripping shuttle which transports the second load of eggs;
the first conveyor line and the third conveyor line form a single main conveyor line and the number of housings N is equal to the number of housings X.

The invention also proposes a method for filling egg transport trays, characterized in that it includes the following steps:
supplying a first conveyor line with egg transport trays comprising N housings each able to receive an egg in the vertical position,
supplying a second conveyor line with individual devices,
a first step of transporting a first load of eggs with the gripping shuttle, from a first tray of the first conveyor line to a first group of individual devices placed on the second conveyor line,
a grouping step during which the individual devices are grouped to form a second individual device group on the second conveyor line,
a second step of transporting a second load of eggs arranged in the second group of individual devices to a tray comprising X housings on the third conveyor line.

### BRIEF DESCRIPTION OF THE FIGURES

Further features and advantages of the invention will become apparent from the following detailed description, which may be understood with reference to the attached drawings in which:

FIG. 1 is a perspective view which shows an individual egg transport device and a gripping member according to the invention;

FIG. 2 is a view in axial section along the sectional plane 2-2 of FIG. 1 which shows the individual egg transport device and the gripping member according to the invention;

FIG. 3 is a view in axial section along the sectional plane 3-3 of FIG. 2 which shows the gripping of an egg placed in the individual egg transport device by the gripping member;

FIG. 4 is a view in axial section along the sectional plane 3-3 of FIG. 2 which shows the gripping of an individual egg transport device by the gripping member;

FIG. 5 is a perspective view which shows a movable gripping shuttle equipped with a series of gripping members according to the invention;

FIG. 6 is a side view which shows the gripping capabilities of the gripping shuttle of FIG. 5;

FIG. 7 is a perspective view which shows a variant of the movable gripping shuttle of FIG. 5 equipped with a series of gripping members devoid of suction cups;

FIG. 8 is a perspective view which shows a facility for filling egg transport trays according to the invention comprising first and second conveyor lines;

FIG. 9 is a top view which shows a part of the facility of FIG. 8 where a pair of trays partially filled with eggs is present on the first conveyor line and a first group of individual devices of a first grouping station on the second conveyor line is empty and waiting to receive eggs from a first load;

FIG. 10 is a perspective view which shows a part of the first station for grouping individual egg transport devices on the second conveyor line;

FIG. 11 is another perspective view which shows a part of the first station for grouping individual egg transport devices on the second conveyor line;

FIG. 12 is a top view which schematically shows the first grouping station after the eggs of the first load have been deposited in the individual devices of the first group;

FIG. 13 is a view similar to that of FIG. 12, which schematically shows the first grouping station after the remaining empty individual devices have been removed from the first grouping station;

FIG. 14 is a view similar to that of FIG. 12, which schematically shows the first grouping station after the release of individual devices equipped with eggs and before they arrive at a second grouping station;

FIG. 15 is a perspective view which schematically shows the second grouping station before the transfer of the load of eggs to trays on the first conveyor line;

FIG. 16 is a view similar to that of FIG. 15 which schematically shows the second grouping station after the transfer of the load of eggs to the trays to be filled and before the transfer of the empty individual devices to a supply zone upstream of the second conveyor line;

FIG. 17 is a perspective view which schematically shows a first embodiment of a device for detaching the individual devices equipping the facility according to the invention;

FIG. 18 is an axial sectional view which schematically shows an alternative embodiment of an individual egg transport device in which the gripping element includes a bump allowing gripping by suction cup.

### DETAILED DESCRIPTION OF THE INVENTION

In the following description, identical, similar or analogous elements will be referred to by the same reference numbers.

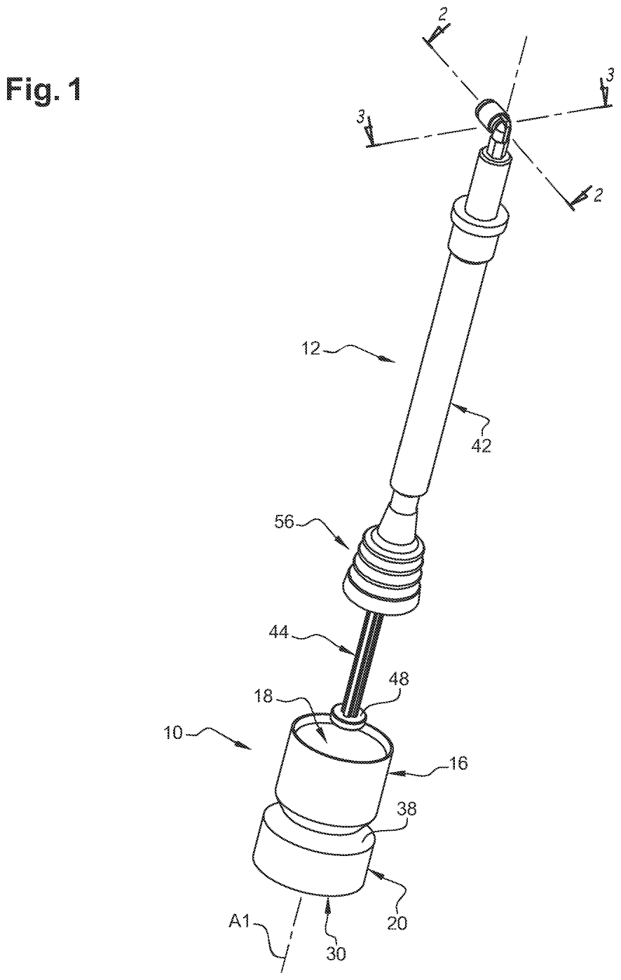

FIGS. 1 to 4 show an individual egg transport device 10 and a gripping member 12 able to grasp either an egg 14, or an individual egg transport device 10.

The individual egg transport device 10 is in the form of a cup and has a generally cylindrical main body 16 with main axis A1. It includes an upper cup 18 designed to receive an egg 14, and in its lower part, a base 20 provided to ensure a stable position of the egg 14 on a conveying element, for example when the individual device 10 is positioned on a conveyor belt.

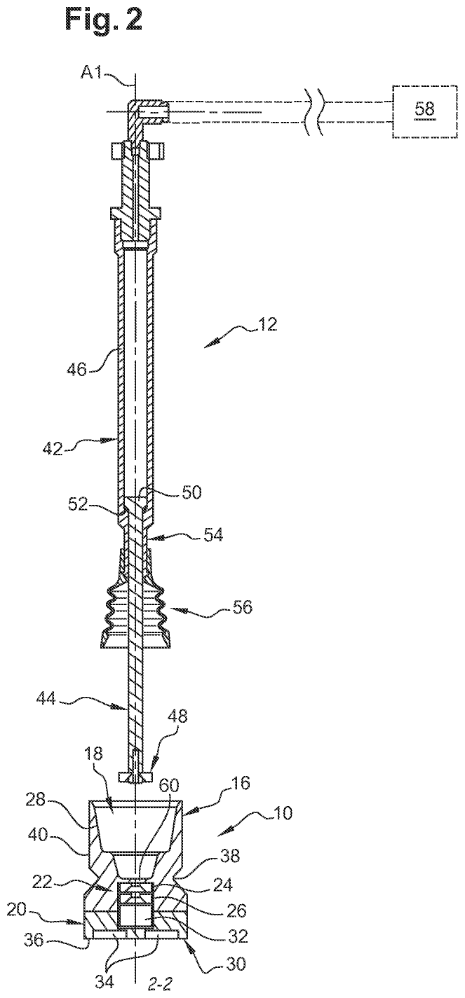

It should be noted that the base 20 may be provided to allow free movement of the individual device 10, either actively by means of the gripping member 12 which grasps the individual device 10 and moves it from a first location to a second location, or passively via a particular arrangement on a conveyor belt, for example fixed storage bars (not shown) that may make it possible to recover the individual devices 10 thanks to the relative movement of the conveyor belt relative to the storage bars. As can be seen in particular in FIG. 2, the individual device 10 includes a gripping element 22 allowing the gripping member 12 to grasp the individual device 10 by magnetic attraction to transport it from a first location to a second location. For this purpose, the individual device 10 here includes at least one magnet 24 arranged in the bottom of a barrel 26 arranged in the main body 16.

The main body 16 of the individual device 10 includes in its upper section a frustoconical bore which forms a receptacle 28, or cup 18, for an egg 14. On the side opposite the frustoconical bore 28, the barrel 26 or cylindrical bore is arranged to receive the magnet 24 forming a gripping element 22. The gripping element 22 here includes two axially superimposed magnets 24. Each magnet 24 for example has the shape of a washer coaxial to axis A1 of the individual device 10.

A lower cover 30 is attached to the lower face of the main body 16. This cover 30 closes the barrel 26 and keeps the magnets 24 in the bottom of the barrel 26. A spacer 32 may be provided between the cover 30 and the magnets 24 to prevent any movement of the magnets 24 in the barrel 26.

The lower cover 30 here forms the base 20 of the individual device 10.

Advantageously, metal parts, here washers 34, are distributed circumferentially in a regular manner on the bottom of the cover 30. According to the embodiment shown, these are three metal washers 34, or pellets, which are screwed into the base 20. These three metal washers 34 here have diameters provided so that they cover the maximum of the lower surface 36 of the base 20.

Advantageously, the main body 16 includes a peripheral groove 38 over the entire periphery of the main body 16, here substantially at the same height as the upper magnet, in the vicinity of the base 20.

Advantageously, the outer diameter of the base 20 and of the main body 16 to the groove 38 is greater than the outer diameter of the upper part 40 of the main body 16, at the upper cup 18 or the receptacle 28.

It should be noted that the gripping element 22 can be a metal part if the gripping member 12 includes a magnet for gripping. According to another variant embodiment, the gripping element 22 and the gripping member 12 could each comprise a magnet to allow gripping by magnetic attraction.

FIGS. 1 to 4 also show the gripping member 12 according to the invention intended to grasp the individual egg transport device 10 described above.

The gripping member 12 includes an arm 42 provided with a gripping rod 44 which is slidably mounted relative to the arm 42 in a main tube 46 along the main axis A1. The free end of the gripping rod 44 includes a gripping tip 48 able to grasp the individual device by magnetic attraction. The gripping tip 48 in this case has the shape of a metal washer with a diameter similar to the diameter of the magnets 24 arranged in the individual device which allows the gripping tip 48 to grasp the individual device 10 by virtue of the magnetic attraction exerted by the magnet 24 on the gripping tip 48. FIG. 4 shows a position of the gripping member 12 when the gripping tip 48 grasps the individual device 10 by magnetic attraction.

According to a variant embodiment, the gripping tip 48 could include a magnet capable of cooperating with a metal washer arranged in the individual device 10.

The gripping rod 44 is here mounted free to slidably move axially in the main tube 46 of the arm 42. The upper axial end of the gripping rod 44 includes a stop 50 with a diameter greater than the rest of the gripping rod 44 so as to cooperate with a shoulder or constriction 52 arranged inside the main tube 46 to axially retain the gripping rod 44 in an extreme low position. It is this position which is shown in FIGS. 1, 2, and 4.

It should be noted that the gripping rod 44 naturally occupies its low position under the effect of gravity, since it is here mounted free to slidably move in the arm 42. According to a variant embodiment, the arm 42 could be provided with a mechanism for controlling the axial position of the gripping rod 44, or an elastic return or damping element could be provided between the gripping rod 44 and the arm 42.

The arm 42 includes, at its free end 54, or lower end, on the side of the gripping tip 48, a suction cup 56 coaxial with the gripping rod 44, able to grasp an egg 14 by suction. The suction cup 56 here has the shape of a bellows that widens downwards to adapt to different egg shapes. The gripping rod 44 is designed to slide axially through the suction cup 56.

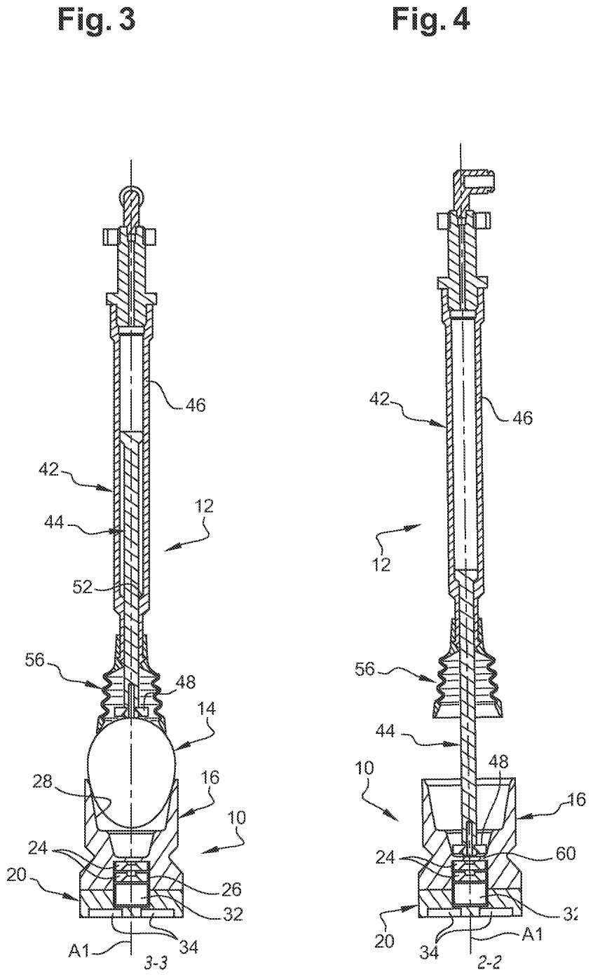

The suction cup 56 is connected to an air suction system 58 through the main tube 46, which allows the suction cup 56 to grasp an egg 14 by suction, or depression. FIG. 3 shows the suction cup 56 in position on the top of an egg 14 for gripping.

It should be noted that the sliding clearance of the gripping rod 44 in the arm 42 is sufficient to allow the air suction system 58 to create lower pressure in the suction cup 56 through the main tube 46.

It should be noted that in the position of FIG. 3, the gripping tip 48 bears against the top of the egg 14 and the gripping rod 44 is pushed upward, inside the main tube 46.

In FIG. 4, the gripping rod 44 is shown in its low position, with the gripping tip 48 positioned in the bottom of the receptacle 28 of the cup 18 so as to allow the magnetic attraction between the gripping tip 48 and the magnets 24. In this position, the gripping tip 48 is therefore stuck against the bottom 60 of the receptacle 28 and the individual device 10 is therefore connected in movement to the gripping rod 44, therefore to the gripping member 12.

Advantageously, the gripping member 12 and the individual device 10 form an assembly for the transportation of egg.

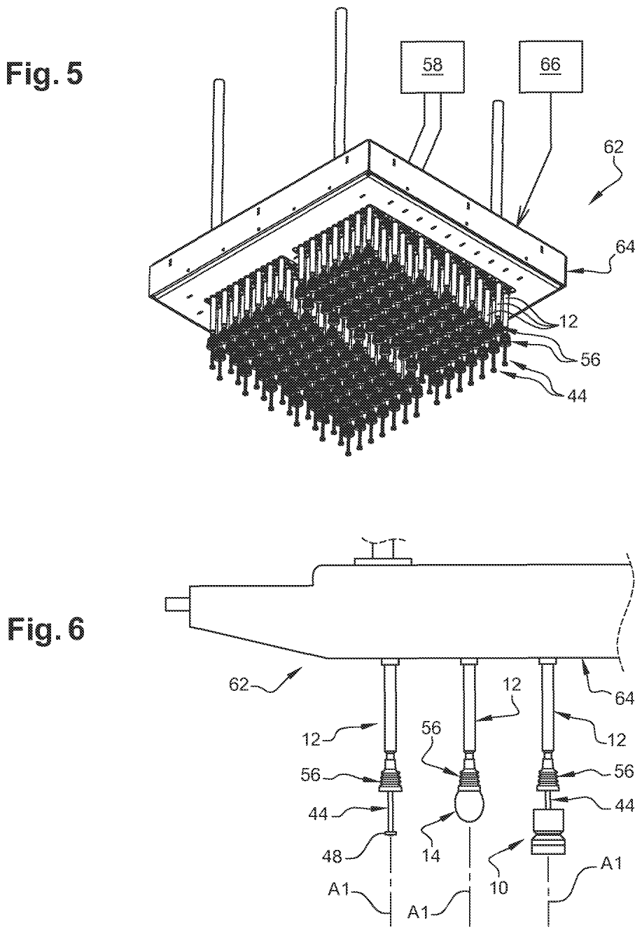

FIG. 5 shows a movable gripping shuttle 62 which includes a multitude of gripping members 12 such as that which has just been described. This gripping shuttle 62 includes a main plate 64, here of generally parallelepipedal shape, and the gripping members 12 are mounted on the main plate 64, on the side of its lower face. The gripping members 12 therefore extend parallel to the bottom in order to be able to grasp a load of eggs 14 and/or a load of individual devices 10, by virtue of the suction cups 56 and the gripping tips 48 respectively.

By way of illustration, FIG. 6 partially shows the gripping shuttle 62 when a first gripping member 12 (on the left in FIG. 6) is empty, that is to say that it is not carrying any element and its gripping rod 44 is in its extreme low position, when a second gripping member 12 (in the middle in FIG. 6) grasps an egg 14 by suction via the suction cup 56, and when a third gripping member 12 (on the right in FIG. 6) grasps an individual device 10 by means of the gripping rod 44.

Thus, the gripping shuttle 62 includes N gripping members 12, these N gripping members 12 being able to grasp up to N eggs 14 arranged either in N housings of an egg transport tray, or in N individual devices 10. These N gripping members 12 are also able to grasp up to N individual devices 10.

Advantageously, the main plate 64 includes a system for adjusting the radial spacing 66 between the gripping members 12, which makes it possible to adapt the shape of the pattern drawn by the series of gripping members 12 to the arrangement of the housings of the egg transport tray and to the arrangement of the individual devices 10 arranged on a flat surface. The gripping shuttle 62 also includes a device for connecting the gripping members 12 to the air suction system 58 so as to be able to control the suction of the eggs 14 by the suction cups 56 of each gripping member 12. The air suction system 58 is also provided to be able to operate in a reverse manner, which allows air to be blown through the suction cup 56 to release the eggs 14 when they have arrived at the destination.

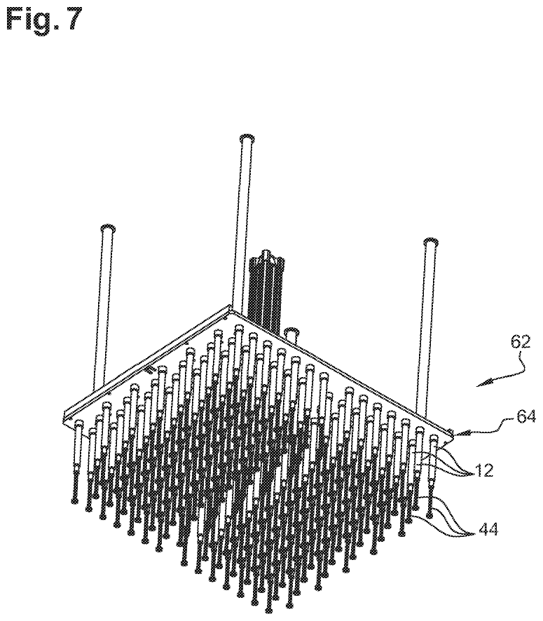

FIG. 7 shows a variant of the gripping shuttle 62 of FIG. 5 in which the gripping members 12 are provided only to grasp individual devices 10 and not to grasp eggs 14. The gripping members 12 are similar to those described previously except that they do not comprise a suction cup 56 and no connection to an air reduction source. This gripping shuttle 62 serves only to grasp and move individual devices 10 devoid of eggs.

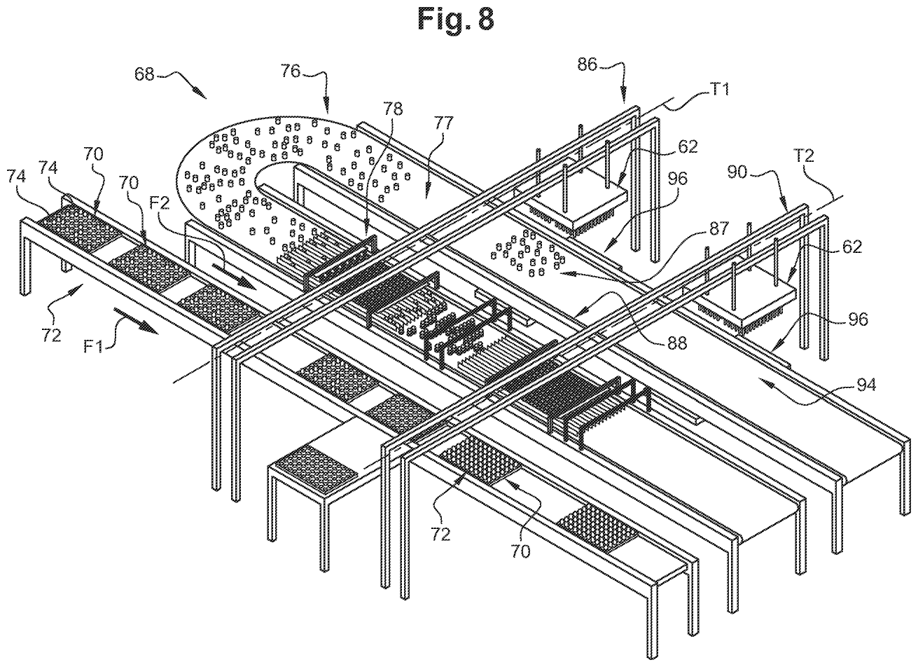

FIG. 8 shows an facility 68 for filling egg transport trays 70 equipped with several gripping shuttles 62, here two, such as that of FIG. 5.

This facility 68 includes a first conveyor line 72, or main conveyor line, which is provided to supply the facility 68 with egg transport trays 70 comprising N housings 74 each able to receive an egg 14 in the vertical position.

In the bottom left part of FIG. 8, the first conveyor line 72 is seen where groups of two adjacent trays 70 arrive incompletely filled with a number M of eggs 14, M being less than N. These trays 70 are conveyed in a first direction of flow F1 from left to right as depicted in FIG. 8.

According to the embodiment shown, the trays 70 arrive in pairs. Of course, the invention also applies to the case where each tray 70 is treated individually and not in pairs.

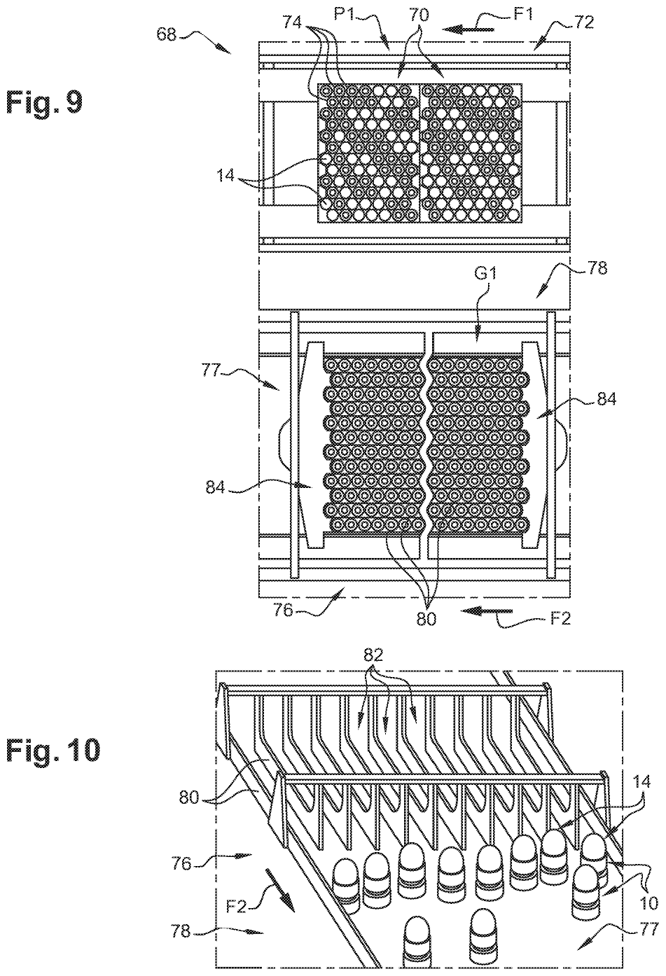

FIG. 9 shows, in its upper part, a section of this first conveyor line 72 with two adjacent trays 70, here partially filled with eggs 14. Schematically, the empty housings 74 are shown here in a circle with a smaller circle inside, while the filled housings 74, that is to say containing an egg 14, are shown in the form of a single circle.

The facility includes a second conveyor line 76 which is designed to convey individual devices 10 parallel to the first conveyor line 72, in a second direction of flow F2, also from the left to the right as depicted in FIG. 8. This second conveyor line 76 here comprises a conveyor belt 77 which brings individual devices 10 placed in a disorganized manner to a first grouping station 78.

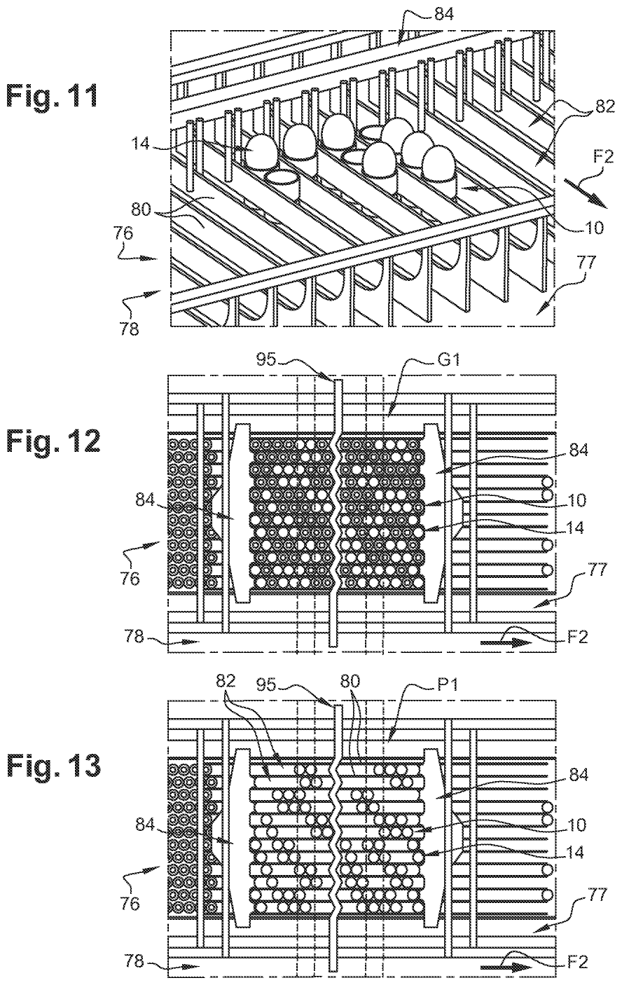

The first grouping station 78 is shown by the lower part of FIG. 9 and by the views of FIGS. 10 to 13. It is placed above the conveyor belt 77 and it includes a series of longitudinal walls 80 parallel to the flow F 2, and forming a number K of dividers 82. Each divider 82 has a width substantially equal to the outer diameter of an individual device 10. Thus, all individual empty devices 10 that arrive from upstream are directed to the dividers 82 to form individual device lines 10. The first grouping station 78 includes cleats 84, or locking rakes, which retain, downstream and upstream, a first group G1 of individual devices 10, the number of which corresponds to the number N of housings 74 on the egg transport trays 70.

The facility 68 includes a first gripping shuttle 62 which is mounted movable on a first gantry 86 so as to be able to move transversely T1 relative to the flows F1, F2. The first shuttle 62 makes it possible to grasp the eggs 14 present on the transport trays 70 arriving on the first conveyor line 72, these being incomplete trays 70 forming a first load P1, and to transport them to the first group G1 of individual devices 10 where it deposits them.

FIG. 9 shows the first grouping station 78 when it is ready to receive the eggs 14 from the first conveyor line 72, the grouping having made it possible to create a first group G1 of individual devices 10 capable of receiving all the eggs 14 present on the two trays 70 of the first conveyor line 72.

FIG. 12 shows the first grouping station 78 after the first shuttle 62 has deposited all the eggs 14 captured in the corresponding individual devices 10. It should be noted that the pattern described by the combination of individual empty devices 10 and full individual devices 10 here corresponds to the pattern of the trays 70 shown in FIG. 9 since the gripping shuttle 62 just took the eggs 14 where they were and to deposit them according to the same arrangement on the second conveyor line 76.

By depositing the eggs 14 of the first load P1 in the first group G1 of individual devices 10, the first gripping shuttle 62 also grips the individual empty devices 10 in which no egg 14 is deposited. Indeed, by moving downwards in order to carefully deposit each egg 14 in an individual device 10, while releasing the suction by the suction cups 56 with a slight air overpressure, the gripping tips 48 also come into contact with the bottoms of the receptacles 28, which causes the adhesion of the associated individual devices 10 by magnetic attraction.

The first gripping shuttle 62 thus makes it possible to transport the individual empty devices 10 toward the area upstream of the second conveyor line 76, here to an intermediate supply station 87 upstream of the second conveyor line 76 which is arranged parallel to the portion where the first grouping station 78 is arranged. Here, this intermediate supply station 87 is connected to the portion where the first grouping station 78 is arranged by a bend.

FIG. 13 shows the first grouping station 78 just after the individual empty devices 10 have been grasped by the first gripping shuttle 62. It should be noted that all that is left are individual devices 10 occupied by eggs 14 and empty spaces therebetween.

After the individual empty devices 10 have been removed from the first grouping station 78, the cleat 84 located downstream is raised which makes it possible to allow the remaining individual devices 10 to pass, all containing eggs 14, so that they move downstream, according to the second flow F2 by virtue of the conveyor belt 77 which operates continuously.

FIG. 14 shows the discharge of remaining individual devices 10 downstream. The individual devices 10 move with the conveyor belt 77 to be grouped downstream on a second grouping station 88.

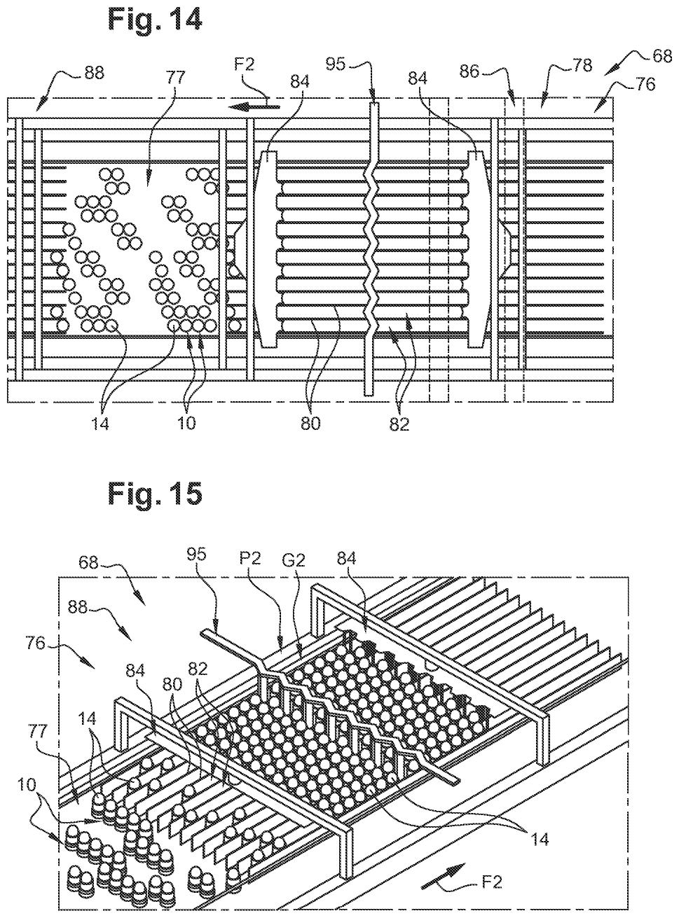

The second grouping station 88, which is shown in particular by FIG. 15, is similar to the first station 78 in its structure. It aims to allow the grouping of individual devices 10 which are all occupied by an egg 14. This second station 88 therefore makes it possible to form a second group G2 of individual devices 10 including N eggs in order to then be able to fill egg transport trays 70 including N housings 74.

This is why the facility 68 here includes a second gripping shuttle 62 which is mounted movable on a second gantry 90 so as to be able to move transversely T2 relative to the flows F1, F2. The second gripping shuttle 62 makes it possible to grasp the N eggs 14 present in the N individual devices 10 of the second group G2, and to transport them to the first conveyor line 72 and deposit them on empty egg transport trays 70 with N housings 74.

For this purpose, the second gripping shuttle 62 is placed above the N eggs 14 of the second group G2, visible in FIG. 15, and lowers the gripping members 12 until the N suction cups 56 can grasp the N eggs 14 by suction to form a second load P2 of eggs 14. The second gripping shuttle 62 can then raise the gripping members 12 with eggs 14 and move in the second transverse direction T2 to a depositing area 92 of the first conveyor line 72 where two empty trays 70 are waiting.

Once it has arrived above the empty trays 70, the second gripping shuttle 62 deposits the N eggs 14 in the N housings 74 by lowering the gripping members 12 and by releasing the suction in the suction cups 76, or even by applying a slight air pressure in the suction cups 76 to release the eggs 14.

The facility 68 according to the invention thus provides complete egg transport trays 70 at the outlet of the first conveyor line 72 which can be sent to a subsequent step of treatment, incubation or to perform any other operation on the trays 70 or on the eggs 14.

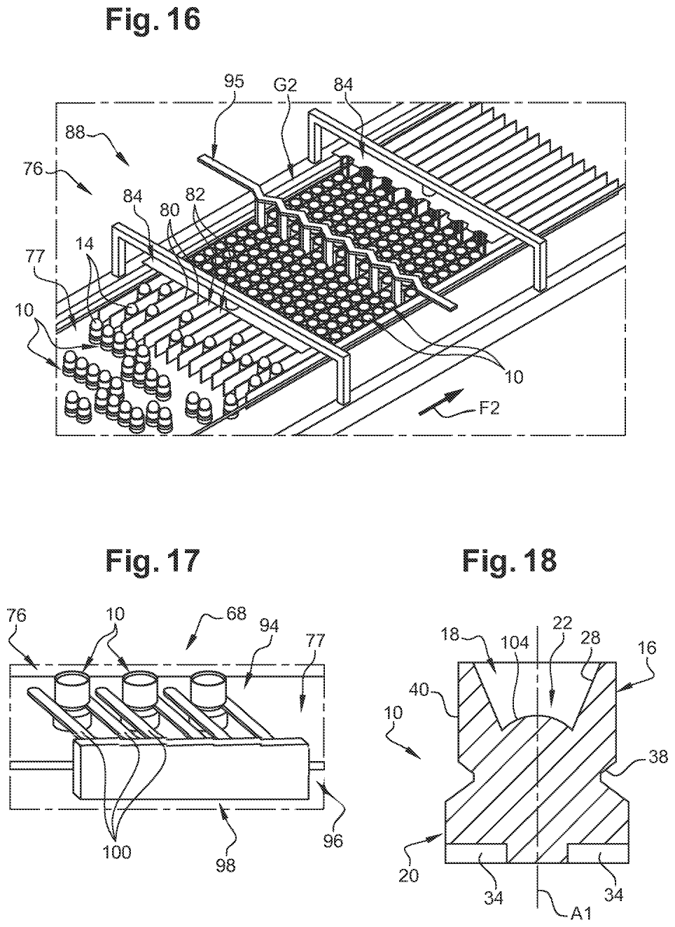

After having deposited the N eggs 14 in the N housings 74 on the first conveyor line 72, the second gripping shuttle 62 can come back to the N individual empty devices 10, which are shown in FIG. 16, to then deposit them in an upstream supply zone 94 on the second conveyor line 76. For this purpose, it is sufficient that the second gripping shuttle 62 brings the N gripping members 12 until the gripping tips 48 mate at the bottom of the receptacles 28 with the individual devices 10 empty. Then, the second gripping shuttle 62 rises and moves transversely T2 to the upstream supply zone 94.

Advantageously, according to the embodiment shown, the first grouping station 78 and the second grouping station 88 each comprise a retractable spacing rack 95 which makes it possible to space the individual devices 10, and therefore the eggs 14, at the junction between the first and the second halves of eggs 14 which correspond respectively to the first and second trays 70 of the pair of trays 70. Of course, in the case where the facility 68 operates by tray and not by pair of trays 70, then this spacing rack is not necessary.

In order to be able to deposit the empty individual devices 10 on the second conveyor line 76, a device for releasing 96 the individual devices 10 is provided in the facility 68.

According to a first embodiment, which is shown by FIG. 17, the releasing device 96 includes forks 98 formed of parallel rods 100. These rods 100 are provided to be received tangentially in the peripheral grooves 38 of the individual devices 10 when a gripping shuttle 62 places them on the conveyor belt 77. The forks 98 make it possible to axially retain the individual devices 10 on the conveyor belt 77 when the gripping shuttle 62 rises with its gripping rods 44. This mechanism makes it possible to overcome the magnetic attraction exerted by the magnets 24 on the gripping tips 48. Once the individual devices 10 are released from the gripping members 12, the forks 98 retract to allow the individual devices 10 to continue their movement with the conveyor belt 77 to the first grouping station 78.

According to a second embodiment, which is shown by FIG. 8, the uncoupling device 96 includes a magnetized plate 102 which positions itself under the conveyor belt 77 when a gripping shuttle 62 comes to deposit the empty individual devices 10 on the conveyor belt 77. This magnetized plate 102 also makes it possible to overcome the magnetic attraction exerted by the magnets 24 on the gripping tips 48, by attracting the individual devices 10 downward, which makes it possible to release the individual devices from the gripping members 12.

Once the individual devices 10 are released from the gripping members 12, the magnetized plate 102 retracts to allow the individual devices 10 to continue their movement with the conveyor belt 77 to the first grouping station 78.

There follows a description of a method for filling egg transport trays 70 according to the invention. This method includes the following steps:
supplying the first conveyor line 72 with egg transport trays 70 comprising N housings 74 each able to receive an egg 14 in the vertical position,
supplying the second conveyor line 76 with individual empty devices 10,
a first step of transporting a first load P1 of eggs 14 with the first gripping shuttle 62, from a first tray 70 of the first conveyor line 72 to the first group G1 of individual devices placed on the second conveyor line 76,
a grouping step during which the individual devices 10 are grouped to form the second group G2 of individual devices 10 on the second conveyor line 76,
a second step of transporting a second load of eggs 14 arranged in the second group G2 of individual devices 10 to a tray 70 comprising N empty housings 74 on the first conveyor line 72.

According to a variant embodiment, the first conveyor line 72 may be dedicated to supplying incomplete egg transport trays 70, and a third conveyor line is provided to collect the second load of eggs and output trays 70 filled with eggs 14 in all of their housings 74. This variant embodiment makes it possible for example to supply the facility 68 with egg transport trays 70 comprising N housings 74 and to fill, at the output, egg transport trays 70 comprising X housings 74, the number X of housings 74 being potentially equal to or different from the number N of housings 74 at the input. In this case, the second grouping station 88 is designed to form a second group G2 comprising X individual devices 10 filled with eggs 14.

According to an alternative embodiment, the first gantry 86 can comprise a third gripping shuttle 62 which makes it possible to transport the remaining empty devices 10 at the first grouping station 78 while the first gripping shuttle 62 will seek out and convey the eggs 14 from the first conveyor line 72 to the second conveyor line 76. In this case, the third gripping shuttle 62 is dedicated to transferring the empty individual devices 10 from the first grouping station 78 to the intermediate supply station 87, or third station.

According to a variant embodiment, which is shown in FIG. 18, the upper cup 18 is provided in the bottom of the receptacle 28 with a surface intended for gripping by a suction cup 56, in addition to or instead of the magnetic system 24. Advantageously, this surface is a bump 104, preferably smooth or polished. This bump 104 allows the individual device 10 to be gripped by suction with the suction cup 56 serving to grip the eggs 14. The bump 104 here has the shape of a convex surface approximating the shape of an egg 14 in order to facilitate the gripping of the individual device 10 by the same suction cup 56 as that provided to grasp an egg 14.

According to this variant embodiment, the gripping member 12 includes only the suction cup 56, but may also comprise both the suction cup 56 and the magnet with the gripping rod 44. The gripping member 12 can therefore grasp either an individual empty device 10, or an egg 14 and the gripping shuttle 62 can therefore grasp both individual empty devices 10 and eggs 14, but also separately from eggs 14 or individual devices 10, depending on the choice of whether or not to aspirate on each suction cup 56.

It should be noted that it is possible to do mechanical suction/blowing; the suction would be mechanically deactivated if in contact with an egg, or no suction if no contact with an egg.

The difference between this variant embodiment and the main embodiment described above lies in the management of the automatic control of the gripping members 12: the version with a bump 104 requires individual management for gripping, moving, and depositing each individual device 10. Indeed, the gripping shuttle 62 and the control of the suction system 58 must determine which are the gripping members 12 provided with individual devices 10 to be released and which are the gripping members 12 carrying eggs 14.

One advantage of the solution with a magnet shown above is that the management of the automation to control the gripping and the movement of the gripping shuttle 62 is simpler since the individual devices 10 are grasped by the gripping members 12 if they are empty, whereas if they are filled, the gripping members 12 can only grasp the eggs 14 if suction is being controlled through the suction cup 56.

According to a variant embodiment of the facility 68 and of the filling method according to the invention, it is possible to detect upon arrival on the first conveyor line 72 if trays 70 are heavily filled, for example more than 75% filled, and in this case not to empty them. It is then provided to form on the second conveying line 78, with a suitable arrangement of eggs 14 in the individual devices 10, an egg filling pattern which makes it possible to complete the very heavily trays 70 on the first conveyor line 72 by depositing the eggs 14 by means of the second gripping shuttle 62 only in the empty housings 74 of the trays 70.

The individual device 10, the facility 68, and the filling method according to the invention allow the complementary filling of egg transport trays 70 by making it possible to complete trays 70 partially filled with eggs 14 such that all the housings 74 of the tray 70 are occupied at the outlet of the conveyor line.

### LEGEND

10: individual device
12: gripping member
14: egg
16: main body
18: upper cup
15: base
22: gripping element
24: magnet
26: barrel
28: receptacle
30: lower cover
32: spacer
34: metal washer
36: lower surface
38: peripheral groove
40: upper part
42: arm
44: gripping rod
46: main tube
48: gripping tip
50: stop
52: constriction
54: free end
56: suction cup
58: air suction system
60: bottom of the receptacle
62: gripping shuttle
64: main plate
66: radial spacing adjustment system
68: facility
70: tray
72: first conveyor line
74: housing
76: second conveyor line
77: conveyor belt
78: first grouping station
80: longitudinal wall
82: divider
84: cleat
86: first gantry
87: intermediate supply station
88: second grouping station
90: second gantry
92: depositing area
94: upstream supply zone
95: spacer rack
96: releasing device
98: fork
100: rod
102: magnetized plate
104: bump
A1: main axis
F1: first direction of flow
F2: second direction of flow
G1: first group
G2: second group
P1: first load
P2: second load
T1: transverse direction of the first gantry
T2: transverse direction of the second gantry

1. An individual egg transport device, characterized in that it includes:
an upper cup provided to receive an egg,
a base provided to ensure a stable position of the upper cup on a conveying element,
a gripping element allowing a gripping member to grasp the individual device in order to transport it from a first location to a second location.

2. The individual device according to claim 1, characterized in that the gripping element comprises a magnet, or a metal part, which is arranged under the upper cup to allow the gripping member to grasp the individual device by magnetic attraction.

3. The individual device according to claim 1, characterized in that it includes a surface such as a bump capable of allowing the individual device to be gripped by a suction cup.

4. The individual device according to claim 1, characterized in that it includes a peripheral groove.

5. The individual device according to claim 1, characterized in that the base includes metal pellets distributed on the bottom of the base.

6. A gripping member intended to grasp an individual egg transport device according to claim 1, characterized in that it includes an arm provided with a gripping rod which is slidably mounted relative to the arm, in that the free end of the gripping rod includes a gripping tip capable of grasping the individual device by magnetic attraction, and in that the arm includes at its free end, on the side of the gripping tip, a suction cup coaxial with the gripping rod, able to grasp an egg by suction.

7. The gripping member according to claim 6, characterized in that the gripping rod is mounted free to slidably move in the arm.

8. An assembly for egg transport, characterized in that it includes a gripping member according to claim 6 and an individual device characterized in that it includes:
an upper cup provided to receive an egg,
a base provided to ensure a stable position of the upper cup on a conveying element, and
a gripping element allowing a gripping member to grasp the individual device in order to transport it from a first location to a second location.

9. A movable gripping shuttle characterized in that it includes at least N gripping members according to claim 6, these N gripping members being able to grasp up to N eggs arranged either in N housings of an egg transport tray, or in N individual devices, wherein each of the N individual devices is characterized in that it includes:
an upper cup provided to receive an egg,
a base provided to ensure a stable position of the upper cup on a conveying element, and
a gripping element allowing a gripping member to grasp the individual device in order to transport it from a first location to a second location.

10. A facility for filling egg transport trays, characterized in that it includes:
a first conveyor line which is provided to supply the facility with transport trays of eggs comprising N housings each able to receive an egg in the vertical position,
a second conveyor line which is provided to convey individual devices, each individual device characterized in that it includes:
an upper cup provided to receive an egg,
a base provided to ensure a stable position of the upper cup on a conveying element, and
a gripping element allowing a gripping member to grasp the individual device in order to transport it from a first location to a second location,
a third conveyor line which is provided to output egg transport trays comprising X housings each able to receive an egg in the vertical position,
at least one gripping shuttle according to claim 9, which is movable between the first conveyor line and the second conveyor line, so that it can:
during a first step, grasp a first load of eggs on a first tray including a number of eggs M less than N, transport the first load of eggs to the second conveyor line, deposit the first load of eggs into a first group of individual devices,
during a second step, grasp a second load of eggs arranged in a second group of individual devices arranged on the second conveyor line, transport the second load of eggs to a third main conveyor line, deposit the second load of eggs into the housings of a tray including X housings.

11. The facility according to claim characterized in that the second conveyor line includes a first station upstream of the conveying flow where the individual devices are grouped to form the first group, and a second station downstream of the conveying flow where the individual devices are grouped to form the second group.

12. The facility according to claim 11, characterized in that it includes a first gripping shuttle which transports the first egg load and a second gripping shuttle which is movable between the first station and a third station arranged upstream, relative to the first station, so as to be able to transport the empty individual devices of the first group from the first station to the third station.

13. The facility according to claim 12, characterized in that it includes a third gripping shuttle which transports the second load of eggs.

14. The facility according to claim 10, characterized in that the first conveyor line and the third conveyor line form a single main conveyor line and in that the number N of housings is equal to the number X of housings.

15. A method for filling egg transport trays, characterized in that it includes the following steps:
supplying a first conveyor line with egg transport trays comprising N housings each able to receive an egg in the vertical position,
supplying a second conveyor line with individual devices, each individual device characterized in that it includes:
an upper cup provided to receive an egg,
a base provided to ensure a stable position of the upper cup on a conveying element, and
a gripping element allowing a gripping member to grasp the individual device in order to transport it from a first location to a second location,
a first step of transporting a first load of eggs with the gripping shuttle according to claim 9, from a first tray of the first conveyor line to a first group of individual devices placed on the second conveyor line,
a grouping step during which the individual devices are grouped to form a second group of individual devices on the second conveyor line,
a second step of transporting a second load of eggs arranged in the second group of individual devices to a tray comprising X housings on the third conveyor line.
